(19) United States
(12) Patent Application Publication
(10) Pub. No.: US 2009/0259892 A1
(43) Pub. Date: Oct. 15, 2009

(54) Method and Apparatus for Producing a Metastable Flip Flop

(75) Inventor: Charles H. Moore, Sierra City, CA (US)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/244,580

(22) Filed: Oct. 2, 2008

Related U.S. Application Data
(60) Provisional application No. 61/124,174, filed on Apr. 15, 2008.

(51) Int. Cl. G06F 11/00

(52) U.S. Cl. 714/47; 714/E11.144

(57) ABSTRACT

The method includes predetermining an output enable time period by measuring the maximum settling time when a signal is read during a transition from 0 to 1 or vice versa, and multiplying the maximum settling time by a safety factor 2.5, to set an output enable time period; reading and latching an input value; and transmitting the latched value onward after the predetermined output enable time period. An embodiment of the apparatus 10 includes two inverters 12, 14 and two pass gates 16, 18 and connected to a line 20 at its input. The pass gates 16, 18 are connected in a multiplexer configuration. A third pass gate 30 for connecting line 32, carrying the (inverted) output B of the metalatch, to further circuit portions, according to a 2-bit output enable signal applied to control lines 34, 36 respectively. In alternate embodiments, other logic circuit portions already provided can perform the function of pass gate 30.

### CROSS-REFERENCE TO RELATED APPLICATIONS

This application claims the benefit of U.S. Provisional Patent Application Ser. No. 61/124,174 entitled “Improvements for a Computer Array Chip”, filed on Apr. 15, 2008, which is incorporated herein by reference in its entirety.

### BACKGROUND OF THE INVENTION

1. Field of the Invention

The present invention relates to the field of computers and computer processors, and more particularly to a means for reading a discrete binary value from a line that can have an intermediate value of electrical potential during signal transitions, especially in asynchronously operating multiprocessor arrays in single-chip embedded systems.

2. Description of the Background Art

It is known in the prior art to use multiple computer processors, working together, to accomplish a task. It is a recent trend to combine several processors on a single chip, and it is thought that for a number of reasons, the best arrangement of multiple processors for many applications might be an array consisting of many computers, each having processing capabilities and at least some dedicated memory. In such an example, each computer will not be particularly powerful in its own right, but rather the computing power will be achieved through close cooperation of the computers.

Copending applications, such as U.S. application Ser. No. 11/810,183 in the name of this same inventor, have described and claimed a number of inventive aspects of such computer arrays, including some specifics as to how such computers may be arranged, and how communications channels between them might occur. However, implementation of the relatively new concept of computer arrays will require yet more innovations in order to operate with the greatest efficiency.

Clearly there are many questions to be answered regarding how best to arrange the circuits of such computer arrays. Some of these questions may have been answered, but there may well be room for improvement even over the existing solutions. It is desirable, especially in multiprocessor arrays used in single-chip embedded systems wherein layout area is at a premium, to employ a minimum number of transistors to accomplish a given circuit function. This can result in a circuit that is otherwise highly effective but has a feature which, under some conditions, can cause undesirable effects. One such effect arises from the analog nature of electrical potential used to represent binary numbers in digital computer circuits, which is well known in the art. The electrical potential of a line, also called a signal, that represents the value of a one-digit binary number, sometimes also referred to as a bit, proceeds through values intermediate between a binary 1, also called a logical high value, and a binary 0, also called a logical low value, during a transition period of time when changing between 1 and 0, in either direction. Computer circuits must accordingly be adapted to read, register, or transmit the potential of a line to other circuit portions, during times that exclude such transition periods. On the other hand, if a computer circuit is not so adapted, and an intermediate value between binary 0 and 1 is applied to another circuit portion, such as a flip-flop, a static memory cell, or a register cell, it is possible that the circuit portion can remain in an intermediate state, also known as a metastable state, for an extended period of time and thereby slow down circuit operation.

Several techniques to prevent or mitigate metastability are known in the art. One known technique is a synchronous circuit that reads and passes data at a fixed clock frequency distributed everywhere in the circuit, i.e., at fixed, predetermined time intervals longer than the greatest expected settling or delay time, and transition period, in the circuit. Synchronous circuits suffer from a speed disadvantage of operating at the speed of the slowest circuit portion, and a layout disadvantage of area lost to clock distribution lines. Further, data from external devices connected to I/O pins and status lines lies outside the internal clock system and is thus basically asynchronous and subject to being read during a transition period.

According to another known technique, the signal to be read is passed through a plurality of flip-flops cascaded in series. The use of, for example, three flip-flops in series, as an “arbiter” circuit to help resolve an intermediate potential to either a 1 or a 0, is known in the art, to mitigate metastablility in asynchronous computer circuits and I/O interfaces. Cascaded flip-flops and other known arbiters have a large number of transistors, large layout area, and consequently require high operating power, and this is disadvantageous especially in embedded, single-chip multiprocessor applications. A need exists, therefore, for an improved technique to avoid metastability in asynchronous circuits.

### SUMMARY OF INVENTION

Accordingly, it is an object of the present invention to provide an apparatus and method for preventing metastability in a computer circuit when reading, registering, or transmitting binary data from a line.

It is another object of the present invention to provide an apparatus and method for reading, registering, or transmitting the electrical potential of a line after it has reached a stable high or low value, and not during a transition period between the high and low values.

It is still another object of the present invention to provide an apparatus and method for reading, registering, or transmitting the electrical potential of a line after it has reached a stable high or low value, and not during a transition period between the high and low values, using a circuit with smaller number of transistors, smaller area on chip, and lower operating power.

Briefly, the present invention is an apparatus and method herein referred to as a “metalatch” for reading, registering, or transmitting the potential of a line in a CMOS computer circuit, that includes two inverters, and two pass gates connected as a multiplexer, which can be further gated to pass a stable high or low potential value to subsequent circuit portions, at a predetermined fixed time interval after initiation of a read operation that can be in asynchronous time relationship with changes of the potential of the line. An inverter portion of the metalatch can be implemented by a pair of CMOS transistors, resulting in a metalatch that has only ten transistors.

### BRIEF DESCRIPTION OF THE FIGURES

In the accompanying drawings:

FIG. 1 is a schematic block diagram of a metalatch according to the invention;

FIG. 2 is a symbolic timing diagram of the operation of the metalatch according to the invention; and

FIG. 3 is a flow diagram showing the asynchronous read method according to an embodiment of the invention.

### DETAILED DESCRIPTION

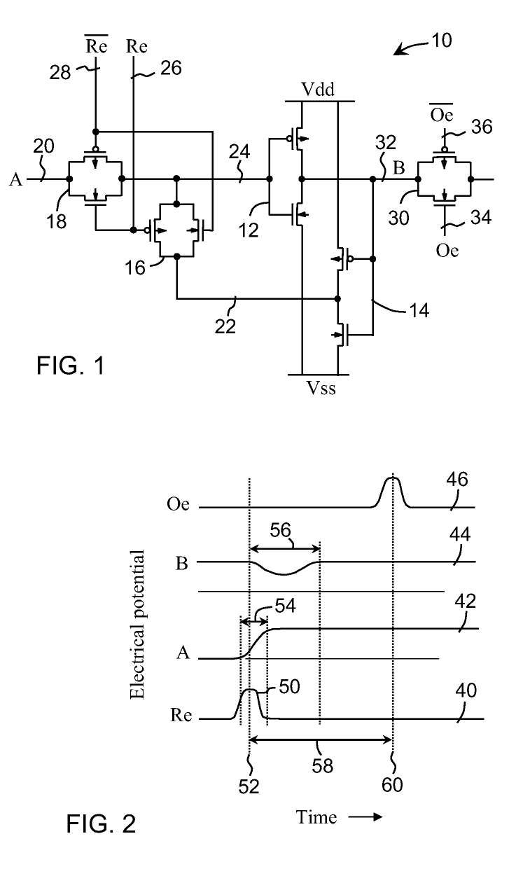

A known mode for carrying out the invention is a metalatch connected to a line, also called a wire, in a computer circuit. The inventive metalatch is depicted in schematic block diagram view in FIG. 1, and is designated therein by the general reference character 10. According to an embodiment of the invention, metalatch 10 includes two inverters 12, 14 and two pass gates 16, 18 and is connected to line 20 at its input. The pass gates 16, 18 are connected in a multiplexer configuration, for connecting either input line 20, or feedback line 22, to input 24 of inverter 12, according to a 2-bit read enable signal Re, R̅e̅ applied to control input lines 26, 28 respectively. Input line 20 can be, for example, a line from an input/output (I/O) pad or I/O pin of a computer on the edge (periphery) of a single-chip multiprocessor array, such as the SEAforth®-24A Embedded Array Processor described in SEAforth®-24A Embedded Array Processor Device Data Sheet (Preliminary Version 1.1, Mar. 7, 2008) published by IntellaSys®, herein after referred to as Data Sheet. In the embodiment shown in FIG. 1, the metalatch 10 includes a third pass gate 30 for connecting line 32, carrying the (inverted) output B of the metalatch, to further circuit portions, according to a 2-bit output enable signal Oe, O̅e̅ applied to control lines 34, 36 respectively. In alternate embodiments, other logic circuit portions already provided can perform the function of pass gate 30.

Operation of the metalatch, according to the invention, can be understood with reference to an example timing diagram shown in FIG. 2. There are shown time-evolution traces 40, 42, 44, and 46 of electrical potentials on lines 26, 20, 32, and 34, respectively, which represent the read enable signal Re, an input signal A to be read, the output signal of inverter 12 (signal B), and the outout enable signal Oe, respectively. When Re is 0 (and R̅e̅ is 1), the feedback line 22 is connected to line 24 through pass gate 16, and pass gate 18 is “off”; and when Re is 1 (and R̅e̅ is 0), line 20 is connected to line 24 through pass gate 18, and pass gate 16 is “off”. It is assumed in this example that a high (Re=1) pulse 50 of the read enable signal Re is produced at a time 52, for example by an I/O pin read instruction, which happens to coincide with a transition time period 54 wherein the input signal A to be read is changing from 0 to 1, as indicated by traces 40 and 42 in the figure. It is further assumed, as indicated by trace 44, that the output signal B accordingly moves from its previous, high, potential value corresponding to binary 1, toward a lower potential for some time but then returns to 1, within a settling time period 56. This value remains latched owing to the closed loop through inverters 12, 14 and pass gate 16, until the next read instruction, not shown. In this example, therefore, the value of A prior to the transition from 0 to 1 is read at time 52, producing in this case an (inverted) output value of 1 on line 32, as shown. In an alternate example, a read enable pulse which happens to coincide with an input signal transition time can result in the value of A after the transition being read, depending on the shape of the input signal transition and its exact time relationship with the read enable pulse.

In an embodiment of the inventive metalatch in a computer of a SEAforth® single-chip multiprocessor array, it has been observed that the time period 56 is approximately 400 picoseconds, within which the output B will settle to a 1, or to a 0, when the input A is read during a transition time period. Accordingly, as indicated by trace 46 in FIG. 2, a high Oe pulse can be applied to line 34 after a predetermined time interval 58 from time 52, to connect (transmit) the latched value read from line 20 (in this example, its inverted value) through pass gate 30 to other circuits further along the data path, which are not shown in the figure, such as a combinatorial circuit portion, latch, register cell, or memory storage cell.

The predetermined time interval 58 can be for example 1 nanosecond, including a safety factor, in the embodiment wherein the settling time 56 is 400 picoseconds. The value on line 20 can be read again shortly after time 60, by applying another Re=1 pulse to line 26 (and a corresponding R̅e̅=0 pulse to line 28).

It will be recognized by those skilled in the art that in an alternate embodiment of the invention, using a different technology environment for implementing a CMOS circuit in a semiconductor chip, the settling time and predetermined time interval can be different from the example described hereinabove. According to the invention, the time interval 58 can be predetermined by conducting a set of measurements of the settling time 56 of the metalatch 10, over a range of relative time positions of the read enable high pulse Re=1 with respect to a transition time period 54 of the input signal A from 0 to 1, and also in the opposite direction from 1 to 0, covering a range before, coincident with, and after the transition; finding the maximum settling time observed; and setting the time interval 58 to be the maximum observed settling time multiplied by a safety factor, which can be 2.5.

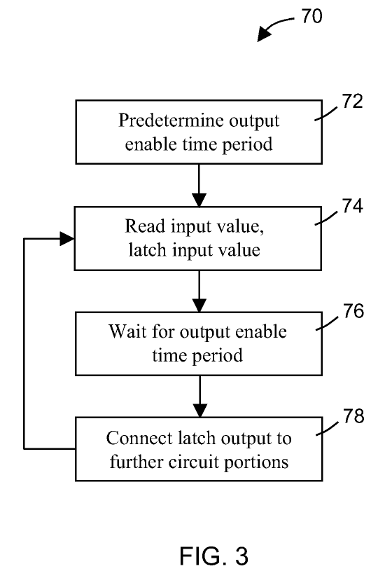

An embodiment of an asynchronous read method 70 according to the invention, that avoids metastability, is shown in flow diagram form in FIG. 3. The method 70 includes step 72 of predetermining an output enable time period 58, by measurement and selection of a maximum settling time period 56 of latch 10 after reading an input value during a transition time period 54, and multiplying the settling time period by a safety factor that can be between 1 and 3 preferably 2.5; step 74 of reading the value of input A by applying a high read enable pulse (Re=1) to pass gates 16, 18 and latching the value by returning the read enable value to low (Re=0); step 76 of waiting for the output enable time period 58; and step 78 of transmitting the latched value to further circuit portions, by connecting (in this case, the inverted) output B of the latch to further circuit portions through pass gate 30, by applying a high output enable pulse (Oe=1) to the gate.

### INDUSTRIAL APPLICABILITY

The inventive computer logic array 10, instruction set and method are intended to be widely used in a great variety of computer applications. It is expected that they will be particularly useful in applications where significant computing power and speed is required.

As discussed previously herein, the applicability of the present invention is such that the inputting information and instructions are greatly enhanced, both in speed and versatility. Also, communications between a computer array and other devices are enhanced according to the described method and means. Since the inventive computer logic array 10, and method of the present invention may be readily produced and integrated with existing tasks, input/output devices and the like, and since the advantages as described herein are provided, it is expected that they will be readily accepted in the industry. For these and other reasons, it is expected that the utility and industrial applicability of the invention will be both significant in scope and long-lasting in duration.

1. A method for preventing metastability in a computer switching circuit comprising the steps of: predetermining an output enable time period, and, measuring the maximum settling time when a signal is read during transitions from 0 to 1 and 1 to 0, and, multiplying the maximum settling time by a safety factor, and setting an output enable time period based upon the output of said multiplying step, and, reading and latching an input value, and, transmitting the latched value onward after the predetermined output enable time period.

2. A method for ensuring a computer switching circuit as in claim 1, wherein said safety factor is between 1 and 3.

3. A method for ensuring a computer switching circuit as in claim 2, wherein said safety factor is substantially 2.5.

4. A computer switching circuit resistant to occurrence of a metastable state comprising: an input providing a digital signal; and, a multiplexer connected to said input having two states switching between said states upon receipt of a pulse from said input; and, a latching circuit for preventing a metastable state in said multiplexer.

5. A computer switching circuit resistant to occurrence of a metastable state as in claim 4, wherein said multiplexer is further comprising a first pass gate connected to said input and a second pass gate connected to said first pass gate in a multiplex configuration.

6. A computer switching circuit resistant to occurrence of a metastable state as in claim 4, wherein said latching circuit includes a pass gate connected to said multiplexor for producing a control signal for preventing a metastable condition.

7. A computer switching circuit resistant to occurrence of a metastable state as in claim 6, wherein an inverter connects said multiplexor to said pass gate.

8. A computer switching circuit resistant to occurrence of a metastable state as in claim 7, wherein said multiplexer is further comprising a second pass gate connected to said input and a third pass gate connected to said first pass gate in a multiplex configuration.

9. A computer switching circuit resistant to occurrence of a metastable state as in claim 8, further comprising two additional inverters connected to said second and said third pass gates.

10. A computer switching circuit resistant to occurrence of a metastable state as in claim 4, wherein said input is connected to the input of a computer on the periphery of a single chip multiprocessor array.

11. An improved bistable computer switching circuit having an input, an output, and a multiplexer, the improvement comprising: a latching circuit for preventing a metastable state in said bistable computer switching circuit.

12. An improved bistable computer switching circuit as in claim 11, wherein said latching circuit includes a pass gate connected to said multiplexor for producing a control signal for preventing a metastable condition.

13. An improved bistable computer switching circuit as in claim 12, wherein an inverter connects said multiplexor to said pass gate.

14. An improved bistable computer switching circuit as in claim 12, wherein said multiplexer is further comprising a second pass gate connected to said input and a third pass gate connected to said first pass gate in a multiplex configuration.

15. An improved bistable computer switching circuit as in claim 14, further comprising two additional inverters connected to said second and said third pass gates.

16. An improved bistable computer switching circuit as in claim 11, wherein said input is connected to the input of a computer on the periphery of a single chip multiprocessor array.
